(19) United States
(12) Patent Application Publication
(10) Pub. No.: US 2022/0207437 A1
(43) Pub. Date: Jun. 30, 2022

(54) METHOD AND COMPUTER SYSTEM FOR IMPROVING THE EFFICIENCY OF A VEHICLE FLEET

(71) Applicant: ADN Context-Aware Mobile Solutions, S.L., Gijón (ES)

(72) Inventors: Fernando Aparicio Martínez, Gijón (ES); Abel Rionda Rodríguez, Gijón (ES); David Martínez Álvarez, Gijón (ES); Alberto Álvarez González, Gijón (ES); David Arbesú Carbajal, Gijón (ES); Sonia Menéndez Rodríguez, Gijón (ES); Adrián García Allende, Gijón (ES); José Luis Bango Bustelo, Gijón (ES); Xabiel García Pañeda, Gijón (ES); Roberto García Fernández, Gijón (ES); David Melendi Palacio, Gijón (ES); Laura Pozueco Álvarez, Gijón (ES); Victor Corcoba Mañaga, Gijón (ES); Alejandro García Tuero, Gijón (ES)

(21) Appl. No.: 17/595,353

(22) PCT Filed: May 19, 2019
(86) PCT No.: PCT/EP2019/062467

§ 371 Date: Nov. 15, 2021

(51) Int. Cl. G06Q 10/04; G06N 5/04; G07C 5/08; G06Q 30/02; G06Q 10/06

(52) U.S. Cl. CPC G06Q 10/047; G06N 5/04; G06Q 10/06315; G06Q 30/0282; G07C 5/0808

(57) ABSTRACT

Method and device The invention relates to a method for improving the efficiency of a vehicle fleet, in particular a vehicle fleet used for public transport, with: a) Determining driving circumstances for vehicles (16) within the vehicle fleet (14); b) Gathering operating parameters relating to an operation of the vehicle fleet (14), including gathering operating parameters for a plurality of vehicles (16) having comparable driving circumstances; c) Determining the service efficiency for at least those vehicles (16) of the vehicle fleet (14) having comparable driving circumstances; d) Determining at least one preferred set of operating parameters for the vehicles (16) having comparable driving circumstances by means of which a desired level of the service efficiency can be reached; e) Determining by way of a computer reasoning system at least one measure for achieving the desired value of the service efficiency parameter, said measure being implementable with respect to at least some of the comparable driving circumstances. Further, the invention relates to a computer system (10).

The invention relates to a method and a computer system for improving the efficiency of a vehicle fleet, in particular of a vehicle fleet used for public transport, such as a bus fleet.

Public transport is a major means of transport in city but also in rural areas. It is marked by a number of vehicles forming a vehicle fleet, such as a bus fleet, a tram fleet, a train fleet or a ship (ferry) fleet. Investment in public transport usually focuses on setting up the infrastructure (e.g. bus or train stops, the train tracks or the like) or to procurement of the required vehicles. Yet, often little attention is paid to investing in an improved operation of the public transport system and in particular of a vehicle fleet operating therein.

Accordingly, the inventors identified a need for improving the efficiency of public transport e.g. in order to open up cost saving potentials and to increase customer satisfaction. More precisely, the inventors determined that evaluating the efficiency of public transport is a primarily manual task so far. Various data have to be summarised appropriately and analysed mainly based on experience. Thus, it has been difficult to objectively identify suitable measures for improving the efficiency. Rather, such analyses and recommendations for improving the efficiency are mostly done on a subjective (and isolated, only partial or incomplete) basis and often do not lead to desired results.

Likewise, performance analysis with help of available software typically requires lots of preparation and customising in order to be applicable to a certain customer (e.g. a certain public transport provider). Moreover, such solutions do not achieve sufficient improvements and can be marked by a low level of automation, e.g. due to requiring lots of manual input and manual data management.

Importantly, any of the solutions available so far suffers from limited possibilities to not only monitor a respective vehicle fleet, but to also identify, communicate or even implement suitable measures for improvement. This concerns in particular the required timeframes. Specifically, it is so far difficult to implement improvements with limited time delays or even in real-time. Rather, existing solutions identify suitable measures only with significant time delays of e.g. several days or weeks and/or may generally rely on potentially outdated historic data.

Note that the efficiency discussed herein may be understood as a measure of how well the vehicle fleet performs while e.g taking its usage of resources into account. That is, the efficiency depends on and could be optimised by means of the available resources. Examples of efficiency indicators are discussed below.

Thus, an object of the present invention is to improve the efficiency of a vehicle fleet (in particular but not limited to a bus fleet) that e.g. operates in a public transport system. In particular, a new way for identifying suitable measures of efficiency improvement is provided, that is marked by a higher degree of objectivity and requires less experience and/or personal (i.e. manual) input.

This object is solved by a method and a computer system according to the attached independent claims. Advantageous embodiments are defined in the dependent claims. Moreover, the features mentioned in the introductory part of this description may individually or in any combination thereof also be provided in the presently disclosed solution, if not evident or mentioned otherwise or evident.

According to basic idea, a computer system and a (computer-implemented) method are suggested which in a data-driven and/or automatic manner identify suitable measures for improving a vehicle fleets' efficiency. For doing so, a computer-implemented reasoning system or, differently put, a computer reasoning system (also referred to as computer model herein, e.g. a rule-based model and/or a computer model resulting from and/or being trained by a machine learning process) is used, said computer reasoning system and/or computer model e.g. defining a (rule-based) relation and/or link between an observed (i.e. measured) state and measures suitable to improve said state. This way, measures can be identified for adjusting the efficiency in a desired manner, for example, so that said efficiency reaches a desired value.

The reasoning system may be a software-based system and/or a software module. It may be configured to, in a generally known manner, draw conclusions from available input data (e.g. gathered data), for example based on logic techniques. One example of a reasoning system is a rule-based computer model as disclosed herein.

Such measures may be identified for any vehicle, driver and/or line within a (e.g. bus) line network that fail to meet a desired efficiency. For example, this may include identifying measures for maintenance (e.g. frequency of tire pressure checks) or operations (e.g. vehicle-line assignment, schedule times). The measures may be communicated and/or implemented directly by the present system, so that continuous improvements of the vehicle fleet are possible. Note that the system may generally operate in real-time (e.g. based on real-time operating data) and may also identify and implement suitable measures in real time or at least within one day.

For identifying a desired efficiency level, the present solution may identify particularly well performing vehicles, drivers and/or lines (i.e. that are marked by particularly high and/or the best service efficiency). This may be done at least partially based on measured data but according to one variant at least partially based on prestored data as well. The operating parameters associated with said driver, vehicle and/or line may define a best-practice-set of operating parameters. This set may correspond to a preferred set of operating parameters for reaching a desired level of the service efficiency (e.g. a desired value of a service efficiency parameter). The identified and preferably automatically communicated and/or implemented measures may help to propagate or, in other words, spread the best practice operating parameters throughout the vehicle fleet.

Different levels of automation may generally be provided. For example, defining or identifying comparable driving circumstances as well as gathering data in a driving-circumstance specific manner may be carried out manually at least from time to time and/or by human experts. This may help to ensure the quality and/or to further train the computer reasoning system. In particular, any of the first determination unit, the settings unit and the driving circumstance definition unit discussed below and/or any of the functions associated therewith may be at least temporarily provided manually (e.g. as an alternative to an automated implementation). This way, an appropriate level of automation can be set for a given use case. A highest level of automation may be achieved when the solution automatically determines best practice driving patterns and implements measures to spread this best practice throughout the vehicle fleet.

In general, the operating parameters may define parameters stemming from an actual operation of the vehicle fleet (i.e. values of the operating parameters resulting from and/or being defined by the way that vehicles of the vehicle fleet operate and in particular drive). Generally put, operating parameters may be parameters defining real (i.e. actually occurring) data, that are preferably measured during operation of the vehicle fleet. In fact, they may have to be measured directly during operation to achieve meaningful results.

This is different from static parameters which are determined by fixed operating framework (i.e. by driving circumstances discussed below). Note, however, that not all dynamic parameters may represent operating parameters but that the driving circumstances discussed below may also comprise dynamic parameters. Generally speaking, a driving circumstance may define the framework and/or static conditions and/or background in or according to which a vehicle operates.

At least some parameters defining a driving circumstance may be largely or even fully determined independently of an actual vehicle operation and/or may not be dynamically measured. Their values may be independent of dynamically changing real world events and conditions. As further explained below, exceptions may be weather conditions or traffic conditions comprised by the driving circumstances that are determined for a currently given operating scenario.

Moreover, driving circumstances may comprise any parameters that are used to identify comparable driving circumstances. The operating parameters, on the other hand, may not serve to identify such comparabilities. This may also be the reason why dynamic characteristics/parameters may still be considered for defining driving circumstances. For example, it may be of interest to identify comparable driving circumstances which are both marked by rainy weather or by high traffic.

Additionally or alternatively, the operating parameters may define actual (e.g. real-time) values for the (planned or targeted) parameters of a driving circumstance. That is, the operating parameters may define actual instances of driving circumstances (e.g. vehicles operating according to the driving circumstances) occurring within the vehicle fleet when driving in/under said driving circumstances. This may e.g. relate to an actual operating schedule compared to a (static) planned schedule or to actual drive coordinates (e.g. GPS coordinates) compared to (static) planned drive coordinates.

The operating parameters may thus comprise parameters describing an instance of (at least part of) a driving circumstance. They may also, additionally or alternatively, comprise parameters describing an (actually) occurring driving pattern (e.g. driving style) of e.g. a certain driver/vehicle. This driving pattern may take place in the context and/or framework of a certain driving circumstance.

Still further, the operating parameters may define parameters that relate to an efficiency of a vehicle operation and/or are usable for determining said efficiency. Such operating parameters may be referred to as efficiency indicators herein. For example, some of the operating parameters may be gathered in order to be compared to target or, differently put, desired parameter values. The latter may be derived from so-called SLA-information (service level agreement), wherein such information may e.g. define target values for at least some of the operating parameters which the fleet operator wants to achieve.

In the below table, examples of parameters defining driving circumstances and of parameters defining operating parameters are listed. The operating parameters may further be categorised as indicated in the table which, however, is only an optional measure. Generally, embodiments of the present invention may comprise any number of and in particular any combination of the below listed parameters.

Note that at least some of these parameters, such as the vehicle, the driver, the area, the line, the scheduled times, the planned driver shifts, a training and/or maintenance plan, may be a complex data structures comprising several types of information or, differently put, several sub-parameters. For example, the driver parameter may comprise information on a driver identification, a historic driver profile, the professional level (e.g. the driver qualifications), received training and so on. Similarly, the vehicle parameter may include information mentioned in brackets in the below table. A complex driving structure, on the other hand, may relate to certain predetermined driving scenarios, such as a roundabout approach or stop approach. It may generally summarize predetermined vehicle operating parameters occurring during said driving scenario, such as an acceleration and/or braking behavior.

| | Operating parameters (optionally categorized according to various categories) | | |
|---|---|---|---|
| | | | Instance of driving circumstances |
| | | | (e.g. by providing specific values |
| | | | for generic and/or planned parameters |
| Parameters | | Efficiency Indicator | of the driving circumstances, said |
| describing driving | | (e.g. for comparisons | values occurring when operating in/ |
| circumstances | Driving pattern | to SLA-information) | according to said driving circumstances) |
| Weather (e.g. | Can bus vehicle | number of | (actual) Time slot |
| weather type) | data | passengers | (actual) Driver |
| Route layout (see | Can bus | Punctuality | Line |
| below) | maintenance | Operating frequency; | Vehicle |
| Line (e.g. line ID) | alarms | Comfort (e.g. | (actual) Weather (e.g. |
| Area (e.g. defined | Cornering | gathered by | heavy rain) |
| by GPS | accelerometer | passenger polls or | (actual) Area (e.g. GPS |
| coordinates) | Inertia driving | surveys) | coordinates) |
| Time slots (e.g. time | (e.g. extent | Fuel consumption | GPS instant coordinates |
| slots marking | thereof) | Satisfaction (e.g. | Training plan |
| comparable | Complex driving | gathered by | Maintenance plan |
| operating conditions | patterns (e.g. | passenger polls or | |
| and preferably | roundabout | surveys relating to | |
| defined by experts, | approach). | overall satisfaction | |
| said operating | Biometric data | e.g. not only with | |
| conditions e.g. | Idling time (e.g. | respect to comfort, | |
| relating to rush | utilization of | but also reliability, | |
| hours) | engine idling | vehicle condition etc.) | |
| Driving schedule | mode) | Breakdowns | |
| Planned driver shifts | | Incidents rate | |
| Vehicle (e.g. vehicle | | Maintenance costs | |
| id, vehicle type, | | | |
| vehicle | | | |
| specification) | | | |
| Driver (e.g. driver | | | |
| ID, driver training | | | |
| level etc.) | | | |

The route layout may be defined by and/or include any of the following: bus stop locations, crosswalks locations; semaphores locations; speed limits locations; roundabout locations.

As will be discussed below, the above parameters (but also any other general driving circumstance or operating parameter) may be derived from different sources. In particular, they may be derived from AVM (Advance Vehicle Monitoring) or ERP databases discussed herein and/or from the vehicle itself. Also, cartographic data (e.g. stored within the system) or weather data (e.g. from online services) may be accessed.

By using a reasoning system as generally suggested by this invention, a largely or fully automatic evaluation and in particular optimization process can be provided. In particular, the identification of suitable measures can be performed largely or fully without manual input, but based on the reasoning system instead and preferably in real-time or with only limited time delays of a few minutes or hours. This limits subjective influences and enables fast adjustments of the fleet operation. Further, the data used for identifying suitable measures can be automatically gathered. Also, the reasoning system can be generated and/or adjusted largely or fully automatically as well, e.g. based an observed change of efficiency after having suggested and/or implemented and (an?) identified measure. This limits the effort, experience and time required for summarizing and/or analyzing data when trying to determine the efficiency. The reasoning system is also highly flexible and may be implemented with limited customization, e.g. by accessing already existing databases. According to one example, measures for improving the efficiency may not only be automatically identified, but also automatically implemented, e.g. by initiating training measures or adjusting operating schedules of the vehicles.

In more detail, a (e.g. computer-implemented) method for improving the efficiency of a vehicle fleet, in particular a vehicle fleet used for public transport, such as a bus fleet, is suggested with:
a) Gathering operating parameters (e.g. according to any of the above examples) relating to an operation of the vehicle fleet and e.g. relating to at least some of the vehicles of the vehicle fleet;
b) Determining a service efficiency (e.g. a value of at least one service efficiency parameter) for at least some of the vehicles of the vehicle fleet;
c) Determining at least one preferred set of operating parameters (e.g. associated with one vehicle) by means of which a desired level of the service efficiency (parameter) can be reached (e.g. a best practice service efficiency parameter amongst the total number of service efficiency parameters);
d) Determining by way of a computer reasoning system at least one measure for achieving the desired level of the service efficiency, said measure e.g. being intended for and/or output to and/or implemented by those drivers, vehicles or lines that so far fail to meet said desired value.

The method may be performed by a computer system according to any embodiment discussed herein. For example, the computer system may comprise at least one computer that is configured to perform one or each of the above and below method steps. Alternatively, the computer system may comprise a computer network in which different computers of said network perform different method steps. A computer may be a unit comprising a processing unit, such as a microprocessor, that is configured to process digital data, in particular by executing software programs by means of the processing unit.

A public transport system may be any transport system which is intended for the general public and/or that is owned, financed or operated by public institutions, such as by a city, county or region.

A vehicle fleet may be formed by a number of vehicles of the same generic kind (e.g. buses, trains, ships, trams). Yet, the vehicles of said vehicle fleet may be of different types and/or models (e.g. due to being produced in different years or by different manufacturers). Moreover, vehicles making up the vehicle fleet may include human driven and/or driverless vehicles. Said vehicle fleet may as well be formed by internal combustion engine vehicles, hybrid vehicles, electric vehicles or a combination of these.

A vehicle fleet may e.g. comprise at least 10, at least 50 or at least 100 vehicles or more.

Vehicles may generally drive along predetermined driving routes. Each driving route may be formed within and/or define the public transport system. Specifically, each driving route may be part of a route network of the public transport system. A driving route may also be referred to as a line of or within a public transport network.

The gathering of operating parameters and more precisely of their respective values may be done by means of a communication link between the vehicles and a computer of a computer system performing the method. The communication link may e.g. be wireless (for example, by being Wi-Fi and/or generally Internet-based). The communication link may, additionally or alternatively, include reading out operating parameters from the vehicle in a wire-bound manner (e.g. by connecting a cable thereto) or by connecting a storage medium such as a USB stick to the vehicle and, after information on the operating parameters have been transferred thereto, to the computer system.

The gathering of operating parameters may be performed at least partially without manual input. For example, it may be performed by regularly and/or continuously recording values of the operating parameters. This is preferably done in a vehicle-bound manner, e.g. by associating recorded values of the operating parameters with a specific vehicle (for example by means of tags or identifiers). Additionally or alternatively, operating parameters may be associated with a driving route and/or driving circumstance discussed below of the vehicle, again for example by means of tags or identifiers.

The operating parameters may be or be determined based on (e.g. digital) operating data of the vehicle. Other possible sources of operating parameters (web-services, operator databases) are likewise discussed herein. Each operating parameter may be a quantifiable entity that is marked by a distinct value, wherein the step of gathering operating parameters may generally include gathering respective values of said operating parameters. Examples of operating parameters are listed above.

Operating parameters may form and/or may be used to define driving patterns of a vehicle e.g. along a certain driving route. A driving pattern may indicate how a vehicle was driven along a driving route by means of the operating parameter values recorded in this connection. It may preferably comprise vehicle ID and/or driver ID. Specifically, a driving pattern may be used to measure the performance of a driver and/or a vehicle. It may comprise the actual measured operating parameters when operating the vehicle in or, differently put, according to a certain driving circumstance. Thus, a driving pattern may comprise a driver ID, a vehicle ID as well as operating parameters associated with said specific vehicle.

The service efficiency may describe how efficiently a vehicle provides its intended service (e.g. by servicing a certain line within a public transport network). It may be represented by a service efficiency parameter that may also be referred to as service efficiency proxy. The service efficiency may be determined in a vehicle-bound, or differently put, vehicle-specific manner. Additionally or alternatively, it may be determined in a driving-route-bound or driving-route-specific manner (that is, it may be associated with the vehicle and/or a certain driving route). This may also include considering a plurality of trips along said driving route as is common e.g. in public transport networks. This way, average values may be produced, such as an average satisfaction or average punctuality e.g. for a complete shift or day trip. Preferably, it is determined in a driving-circumstance-specific manner and in particular with respect to driving circumstances that have been identified as being comparable according to one of the below aspects. That is, vehicles and/or drivers of the vehicle fleet may be identified as operating according to comparable driving circumstances and the service efficiency may be determined based on operating parameters of said (comparable) vehicles. As further discussed herein, the driving circumstances may be marked by other parameters as well, such as weather conditions or operating time slots.

The service efficiency may be or be based on an actual measured entity or parameter. For example, the service efficiency may be determined based on e.g. further processing and/or computing at least one actually measured entity or parameter. As noted below, this may also include taking reference information and in particular expected performance and/or expected operating parameter values into account, such as the SLA-information mentioned above. In one example, the service efficiency (parameter) is one single quantifiable parameter, thus rendering it particularly comprehensible and informative. Moreover, the service efficiency may result from a comparison of at least one actually measured operating parameter to a SLA-value (i.e. a target value) determined for said operating parameter. Generally, the closer actually measured parameters are to desired target (SLA) values, the higher may the value of the service efficiency be set. The parameters as well as the target values may be gathered and/or defined with respect to an operation including several trips along a predetermined driving route. For example, the whole operation of a vehicle and/or driver for a given shift, day or time slot may be considered.

The preferred set of operating parameters may be associated with one specific vehicle, driver and/or driving pattern. It may summarize operating parameters that have enabled a vehicle and/or driver to deliver one of the best practice(s) or the best practice in terms of efficiency (for a given driving circumstances?). Such a best practice may be marked by the highest or an at least above-average service efficiency. Accordingly, the preferred set of operating parameters may relate to an above average performance in terms of efficiency and generally to a real-world (i.e. measured) driving pattern.

Thus, determining the preferred set of operating parameters may include identifying the driving pattern (and/or vehicle or driver) producing the best (or at least above-average) service efficiency. This may be done for a given driving circumstance. Also, it may include selecting the operating parameters associated with a driving pattern (and/or vehicle or driver) as the preferred set of operating parameters. Afterwards, this preferred set may be spread to more entities/participants of the vehicle fleet that operate according to comparable driving circumstances, e.g. by applying the identified measures also to those entities/participants.

Note that the desired level of the service efficiency may be the level of the service efficiency associated with that driving pattern (and/or vehicle or driver) to which the preferred set of operating parameters belongs.

The reasoning system may be a computer-implemented model (also only referred to as “model” in the following). Specifically, it may be a rule-based model and in particular a decision tree model. The reasoning system may be provided e.g. in a storage unit of the computer system and/or as part of a software program that is executed by the computer system. It may be generated and/or updated as a part of the invention. According to one embodiment, the method and computer system include generating and/or updating the reasoning system based on the gathered and determined parameters. Thus, the reasoning system may generally be computer-implemented, i.e. computer-executed and/or computer-based, e.g. by being defined as or being based on instructions that are executable by a computer processing unit, such as a microprocessor.

The reasoning system may be associated with and/or refer to a knowledge database. Said knowledge database may be updated as a part of this invention. Methods for updating include and are not limited to the feedback mechanism discussed herein (see effect indicator below) or updates based on human/expert knowledge. Generally, such updates help to create a dynamic and evolutionary reasoning system.

The reasoning system and/or model and in particular the rules implemented therein may be generated and/or trained by a machine learning process. Generally, the reasoning system may define which measures should be recommended in which scenarios. Accordingly, said measures may be determined as a function of presently determined operating parameters, a set of preferred (best practice) operating parameters and/or of service efficiency parameters in particular for vehicles, drivers or other participants that do not achieve the best practice operating parameters.

In a generally known manner, the reasoning system (in particular when implemented as a decision tree) may link states (or nodes) to one another by decision rules (or association rules), such as TRUE, FALSE, LARGER THAN, SMALLER THAN or time conditions. These links may be formed during a machine learning process and e.g. based on a training dataset. Also, initial definitions e.g. through experts may be provided. Moreover, these links may be updated based on an observed effectiveness of identified measures. Specifically, based on feedback on an achieved effect of a measure (see effect indicator below) the state/nodes and decision rules linking them can be updated to take into account of an observed effectiveness of a recommended measure.

Starting from a given state (e.g. a given set of operating parameters associated with a vehicle, driver and/or line or aggregations thereof), it can be determined which measure should be recommended. This can include, for example, determining which decision rules are to be followed and thus moving in a stepwise manner from state/node to state/node until a recommendable measure has been identified. The model and in particular the decision tree may thus define a (e.g. digital or software-encoded) decision flowchart. The reasoning system and/or model may generally take account of a difference between operating parameters associated e.g. with a certain vehicle or driver and the preferred (best practice) operating parameters. It may also consider groups of operating parameters and/or interrelations therebetween. In the context of the machine learning process, the reasoning system and/or model may be trained and tested in a generally known manner before using it to perform a data analysis and/or for generating recommendations. This may be part of the claimed method and system.

The reasoning system and/or model may be based on or comprise a Rete-type algorithm. This is an established class of algorithms that can be used to define rule-based computer-implemented models. Yet, this class has not been used so far for the specific purpose of the invention and not been adapted according to the specifics of the present invention (e.g. for processing the specific data in the specific manner disclosed herein).

Determining measures for achieving a desired adjustment of the service efficiency may also be referred to as generating recommendations herein (i.e. the determined measures representing and/or being output as respective recommendations). The desired adjustment may generally be an increase of the service efficiency, for example, at least to a desired value, such as a minimum acceptable threshold.

According to one embodiment, the computer reasoning system determines the (e.g. identified and/or implemented) measure based on a comparison of at least part of the gathered operating parameters to the preferred set of operating parameters. Specifically, it may compare operating parameters of a vehicle or driver falling short of the desired efficiency level to the preferred set of operating parameters and e.g. based on a difference therebetween identify suitable measures. This may include defining driving circumstances and identifying comparable ones thereof as discussed in further detail below.

According to a further variant, the preferred set of operating parameters stems from a vehicle having a better than average and in particular the best service efficiency. As previously noted, the preferred set of operating parameters may thus represent a best practice.

Additionally or alternatively, the preferred set of operating parameters can be identified based on or from at least one prestored preferred set of operating parameters and e.g. from a repository of such operating parameters. Such prestored sets may be gathered, evaluated and/or classified in advance, e.g. from other vehicle fleet evaluations (e.g. data exploitations). They may act as reference best practices. In particular, a database including such reference best practices may be provided. Preferably, said database is classified by operating parameters (e.g. efficiency level, driving parameters and/or driving circumstances). Generally, such prestored information can be used to better train the system, while establishing the actual preferred set of operating parameters.

The determined measures may be output by a computer of and/or connected to the computer system. In one example, they may be output by means of a software application that is run on a mobile computing device, such as a smartphone. This way, the determined measures may be directly output to drivers of the vehicle, thus resulting in a direct communication and direct reaction (e.g. in real-time) to observed vehicle operations. Additionally or alternatively, the measures may be automatically implemented in a (computer-implemented) network operating system, such as an ERP system/database discussed below. This e.g. concerns adjusting scheduling information according to which the vehicles should operate. Further examples of determined measures are reassignments of drivers and vehicles (e.g. to different lines within a line network of the vehicle fleet), increasing the number of vehicles e.g. on specific lines showing low efficiency, launch specific training actions to drivers (e.g. in person or via the above-mentioned software application) as well as maintenance plan modifications (e.g. to increase vehicle reliability).

As noted above, according to one embodiment of the method and computer system, a distinct generation of the computer reasoning system and in particular a computer model, such as a decision tree, is provided. This may e.g. be done as an initial stage of the method or during an initial operation of the computer system. After the reasoning system has been generated, it can then be employed to determine measures for efficiency adjustment (and in particular improvement or, differently put, increase). Nonetheless, the reasoning system may be further upgraded, fine-tuned, trained and/or updated based on continued data and parameter gathering, even when recommendations are already generated and output. This may include fine tuning and/or updating the reasoning system based on feedback on how effective a recommended measure actually was in terms of increasing the efficiency. Thus, the reasoning system may be dynamically adjusted based on an effect indicator discussed below.

Each operating parameter may be one of or may be determined based on at least one of the following, wherein said operating parameters may again be specific to a certain vehicle and driving route and/or may be determined for or while driving along said driving route:
a vehicle service identification, such as a route or line identification (i.e. which service is provided by the vehicle or, differently put, which route or line is serviced by the vehicle).
An inertia driving, for example an extent of inertia driving that is e.g. expressed as (a share of) a travelling distance or a travelling time of inertia driving compared to the total distance/time. A state of inertia driving may generally relate to a state of driving (i.e. moving) the vehicle at zero or close to zero fuel consumption (e.g. at idling fuel consumption or at less than 10% of an average fuel consumption). The term “driving” herein generally implies a velocity that is different from zero.
An average speed.
An occurrence (e.g. frequency or total number) of vehicle alarms or vehicle failures, in particular CAN bus alarms.
A driver stress level or, generally, biometric data of the driver. This may be determined with help of sensors, such as biometric sensors or electrodermal sensors, which may e.g. be included in watches or bracelets. Such sensors may e.g. determine a pulse rate of the driver.
An approach of the vehicle to predetermined stops (such as a bus stop) or to roundabouts, road crossings, traffic lights and so on. Such approaches may also be comprised by the complex driving patterns mentioned above. For doing so, a value expressing the performance during such approaches may be determined, said value e.g. expressing a closeness of an observed actual approach to an ideal and/or reference approach. An approach may generally be defined as a movement pattern of a vehicle in a timeframe or time window. For example, the decrease of velocity in said timeframe or time window may be considered as defining an approach can be analyzed for evaluating said approach.
A utilization of an engine idle mode, e.g. a value expressing a deviation of an observed utilization compared to a reference and/or ideal utilization.
A utilization of a retarder and/or of air conditioning and/or of braking devices, e.g. a value expressing a deviation of an observed utilization compared to a reference and/or ideal utilization.
A passenger comfort level, e.g. a feedback value generated based on passenger surveys, for example, via software applications for mobile computer units, such as smartphones.
An occurrence of critical driving situations, e.g. a value expressing the frequency and/or total number of observed critical driving situations. A critical driving situation may e.g. be defined by a ratio of velocity to a steering angle (e.g. when driving too fast into roundabouts) or by an extent of the positive or negative acceleration.

Further examples of operating parameters can be found throughout this disclosure and are e.g. summarized in the above table.

Accordingly, for each trip along a predetermined driving route, any of the above operating parameters (or different operating parameters) may be determined and they may be stored as a dataset. Such datasets may represent driving patterns observed along respective driving routes and may be associated with the specific vehicle and/or driver. It has been found that each of the above parameters represents a reliably detectable entity as well as a good estimate of parameters that should be improved and/or might currently diminish the achieved efficiency.

In a further embodiment of the method and computer system, the service efficiency is determined based on comparing at least one of the operating parameters (e.g. of a specific vehicle or drive pattern) to a target value of said operating parameter. Said target value may correspond to a SLA value or stem from the SLA information mentioned above. An operating parameter evaluated in this manner (i.e. to determine the efficiency) may also be referred to as an efficiency indicator herein.

For example, one or more of the following operating parameters along with respective target values may be considered for determining the service efficiency:
a vehicle fuel consumption;
a punctuality of the vehicle, e.g. with respect to a predetermined schedule;
an occurrence of vehicle malfunctions, e.g. a total number or frequency. Vehicle malfunctions may generally represent and be gathered as a key performance indicator of a bus operator;
a passenger satisfaction, e.g. expressed as a value relative to a maximum satisfaction;
a number of transported passengers;
the costs per transported passenger;
a rate of incidents.

Each of these parameters enables a reliable and good estimate of the achieved efficiency.

The service efficiency may be determined as one quantified (service efficiency) parameter, for example as a relative value on a reference scale, such as a scale of 1 (minimum reference value) to 10 (maximum reference value). For doing so, any of the above parameters may be determined as a relative value on a similar scale for said parameter. In case of a plurality of parameters being considered, a plurality of respective scaled values of these parameters may be considered for determining the efficiency (e.g. by averaging them)

According to a further example of the method and computer system, for determining the service efficiency, reference information on an expected efficiency are considered (preferably again with respect to a predetermined driving route or to a different route which is marked by comparable driving circumstances). The reference information may be derived from an ERP system. The reference information may correspond to the SLA information discussed herein.

Additionally or alternatively, the service efficiency may be determined based on normalizing at least one operating parameter by means of a target value for said operating parameter (e.g. by scaling the operating parameter based on said target value, the target value e.g. representing a maximum value, and/or by forming a ratio of the operating parameter and the target value). This increases the meaningfulness of the overall result, in particular when comparing efficiencies of different drivers, vehicles or routes within the vehicle fleet. Note that in case a plurality of operating parameters are considered, each of them may be normalized accordingly and an overall efficiency is preferably determined based on the respective plurality of normalized parameter values.

According to a further example of the method and computer system, driving circumstances for vehicles within the vehicle fleet are determined and at least step a) is performed for at least two vehicles having comparable driving circumstances. A driving circumstance may also be referred to as “driving background”. It summarizes (static and/or expected) conditions or, differently put, a framework in which a vehicle drives and/or which it is exposed to, in particular when driving along a predetermined driving route. Examples of parameters comprised by a driving circumstance are listed in the table above.

Differently put, a driving circumstance or driving background represents a division of the provided service (e.g. public transport service and/or vehicle service) according to temporal and/or spatial characteristics, said division being preferably deterministic. Additionally or alternatively, it may comprise the resources used to fulfil a required (e.g. vehicle or public transport) service within such a division.

Generally, determining comparable driving circumstances serves to provide a reference, framework or basis in which (or with respect to which) efficiency can be measured. That is, according to some embodiments, it is preferred to determine the efficiency with respect to actually comparable operating scenarios to produce meaningful results. For doing so, vehicles that are operated according to comparable driving circumstances can be identified and their operating and/or efficiency parameters can be used for determining an achieved efficiency and/or measures for improving said efficiency.

In particular, the operating parameters of the vehicles e.g. when servicing a certain driving route may indicate a service performance efficiency of said vehicle. In order to determine the efficiency and/or measures for improving said efficiency, service performances of vehicles operating according to similar driving circumstances may be considered. This takes into account that the achievable efficiency may be subject to given (e.g. static or geographic) circumstances that cannot be altered, so that vehicles operating in unrelated driving circumstances might not be sufficiently comparable to one another. Accordingly, the present embodiment helps increase the number of data that (due to the comparability) can be jointly analyzed and thus the chances of delivering useful results.

Likewise, considering comparable driving circumstances helps to increase the number of vehicles, drivers, drive patterns and/or lines for which suitable measures can be identified. For example, in case a measure has been identified for improving the efficiency of a vehicle operating according to a certain driving circumstance, it can be concluded that this measure is also suited for comparable driving circumstances. Thus, more drivers and/or vehicles may profit from the identified measure and may e.g. be trained accordingly.

Note that the disclosed solution may determine the efficiency and/or measures for improving the efficiency only with respect to vehicles operating in comparable driving circumstances. That is, the efficiency, operating parameters as well as measures according to the above step c) may be determined for a certain group of comparable driving circumstances (i.e. may be driving-circumstance-specific). Of course, this can be done for a number of respective groups of comparable driving circumstances that have been identified e.g. in a public transport network. Generally, a step of identifying comparable driving circumstances may be carried out as an initial measure and in the following, any of the further steps and features discussed herein may be applied to groups of vehicles and their associated data that are initially identified as operating according to comparable driving circumstances.

The driving circumstances may be marked by at least one of the following information (and preferably by any combination of a plurality thereof), said information preferably being considered for identifying comparable driving circumstances:
A driving route layout, e.g. a course of the driving route within a public transport network. This may include information such as length or share of straight sections, types of roads or curves along the driving route, each preferably with a respective positional information (e.g. GPS coordinates and/or relative distances). Additionally or alternatively, the driving route layout may be marked by a length of the driving route and/or by a geographical area covered by the driving route;
A driving schedule along a driving route, which may include information on any of a desired start time, an end time, a lap time (driving back and forth between start and end point) and/or intermediate stop times at predetermined (bus) stops. Note that the driving schedule may also define a general operating point of time, such as a week day, operating on the weekend, operating in the morning or afternoon etc.
The type of the used vehicle, such as its model or manufacturer. Generally, an ID such as a serial number or inventory number of the used vehicle may also be provided;
Predetermined stops along the driving route, which may be identified by respective positional information (e.g. GPS coordinates and/or relative distances);
An average passenger number, e.g. per day or for one trip along the driving route. The latter may be calculated as the average number of passengers travelling at the same time in the vehicle, e.g. based on determining the number of entering and disembarking passengers at predetermined stops along the driving route;
An average slope along the driving route;
A number of traffic lights and/or crosswalks along a driving route;
(e.g. average) Weather conditions, that are for example experienced when travelling along the driving route. The weather conditions may include an average temperature, information on precipitation (rain or snow), road conditions (dry, wet, slippery, frozen) etc.

In a further embodiment, the number and/or extent of considered information that are considered as a part of the driving circumstances is adjusted when failing to determine (a vehicle with) a comparable driving circumstance and/or when failing to identify a preferred set of operating parameters based on a current definition of comparable driving circumstances (e.g. based on current groups of driving circumstances that have been defined as comparable). In particular, the number and/or extent of considered information may be reduced. This adjustment may be done as many times as necessary (i.e. iteratively) until a set or group of comparable driving circumstances has been identified.

Identifying comparable driving circumstances may be performed with help of a (machine learning) computer model, such as neuronal network. Likewise, a neuronal network can be used in later stages to identify preferred operating parameters and/or a best practice driving pattern to maximize the efficiency. In this context, the model may optionally compute a (e.g theoretic, ideal and/or virtual, but not necessarily actually performed) preferred set of operating parameters and/or a best practice driving pattern from data that have been gathered from actual vehicle operations.

For example, the number of types of information in the sense of variables which from the driving circumstances (i.e. are comprised by the driving circumstances or considered as part of the driving circumstances) may be reduced. For example, at least some of the above listed information may initially be considered but, in case no match to driving circumstances of further vehicles is found, some of them may be deleted.

Additionally or alternatively, the extent of at least some of the initially considered information may be adjusted. In this case, the information as such (i.e. the type of information) may still be considered as part of the driving circumstances. Yet, the extent or scope of this information may be adjusted, so that a match with driving circumstances of a further vehicle is more likely. For example, a longer time span may be considered than e.g. defined by the actual driving schedule or a larger (geographical) area than e.g. defined by an initial driving route layout.

Overall, the adjustable definition of driving circumstances increases the chances that comparable driving circumstances are identified and may also increase the relevance of identified matches. In particular, it may help to identify preferred sets of operating parameters that are e.g. identified based on or from groups of comparable driving circumstances, wherein said sets may provide a minimum level of preference (e.g. by deviating from a target efficiency by not more than a certain threshold).

Additionally or alternatively, a criterion for determining whether or not driving circumstances are comparable may be adjusted. Again, this may be iteratively done in case no comparable driving circumstances are initially identified. Generally, this may include widening an initially narrow criterion in order to increase the chances of finding comparable driving circumstances.

According to a preferred embodiment, the criterion for determining whether or not driving circumstances are comparable is adjusted as a function of a training level of the computer reasoning system. Generally, the higher the training level, the better the chances of identifying comparable driving circumstances. Thus, the criterion may be defined more strictly or narrow at higher training levels, since the chances are higher that even with such a strict criterion, comparable driving circumstances may still be identified. Note that a stricter criterion will typically result in comparable driving circumstances actually being closer and more related to one another and may thus be preferable.

The criterion may generally define maximum acceptable deviations between at least some of the parameters of different driving circumstances. A stricter criterion may result in smaller acceptable deviations.

According to a further embodiment of the method and computer system, an effect indicator for a measure determined in c) is determined and the computer reasoning system is adapted based on said effect indicator. The effect indicator may indicate an effect that is reached by implementing the measure determined in c). For example, the effect indicator may be determined as or based on a difference of the service efficiency after said measure has been implemented and e.g. after a predetermined time span has lapsed. This embodiment may provide a backloop for adjusting the reasoning system based on an actually observed improvement.

Such observations can be used as training data for the computer reasoning system. In a generally known manner, reasoning systems and/or computer models can be trained based on training data e.g. by way of machine learning processes, as a result of which the reasoning systems are adapted (e.g. by their underlying mathematical model/equation being adjusted). For example, the above discussed links, rules or relations defined by the reasoning system can be adapted by changing them or associated weights or by forming new links.

Generally, the reasoning system can be adapted in terms of which measures are generally recommended in c) and/or which measures are recommended in view of a currently present state (e.g. a current state of (operating) parameters at the input side). In case little or no effects have been observed by way of the effect indicator, a measure recommended according to c) may be deleted from a repertoire of recommendable measures or may be downweighted or otherwise marked as not being as effective as assumed. To the contrary, in case of significant and in particular above-average effects, a measure may be upweighted or otherwise marked as being particularly effective.

According to a further example of the method and computer system, a measure determined in step c) is one of:
Adjusting a frequency and/or scheduling of vehicles along at least one driving route (or line), in particular in reaction to low passenger satisfaction. For example, the frequency and/or scheduling may be increased in case the passengers are dissatisfied with the availability of vehicles. On the other hand, in case the passengers are dissatisfied with the driving style and generally criticize the comfort, the frequency and/or scheduling may be too harsh and should be softened in order to allow for a smoother driving style. Note that the system could also automatically recommend training measures for drivers in case of changing the frequency and/or scheduling, so that the drivers can adjust thereto.
Determining training tools and/or training methods and/or rewards for staff members (for example drivers, maintenance personal, route planners) that work with the vehicle fleet. Training may be suggested in case of detecting potential for improvement, whereas rewards may be recommended and/or output in case of detecting above average performances.
Adjusting a maintenance schedule of at least some of the vehicles of the vehicle fleet. This may be relevant in case of detecting above average mechanical incidents and/or fuel consumption for certain vehicles of the vehicle fleet.

Generally, any recommended measure can be stored and optionally any effectiveness (effect indicator) observed in response thereto can be stored as well and can be used to generate information on what should be done and, possibly, what effects are observable or have been observed in the past.

A recommended measure can be output to software applications that are e.g. run on smartphones of the drivers, so that the drivers can be trained by way of said software application. Additionally or alternatively, recommended measures may include a personal training of the drivers.

The invention also relates to a computer system for improving the efficiency of a vehicle fleet, in particular a vehicle fleet used for public transport, the computer system having:
a) a gathering unit that is configured to gather operating parameters relating to an operation of the vehicle fleet;
b) a first determination unit that is configured to determine the service efficiency for at least some of the vehicles of the vehicle fleet as well as at least one preferred set of operating parameters by means of which a desired level of the service efficiency can be reached; and
c) a second determination unit that is configured to determine by way of a computer reasoning system at least one measure for achieving the desired value of the service efficiency parameter.

Differently put, the invention also relates to a computer system for improving the efficiency of a vehicle fleet, in particular a vehicle fleet used for public transport, the computer system being configured to perform the following measures (e.g. by any of the above units):
a) Gathering operating parameters relating to an operation of the vehicle fleet;
b) Determining the service efficiency for at least some of the vehicles of the vehicle fleet;
c) Determining at least one preferred set of operating parameters by means of which a desired level of the service efficiency can be reached;
d) Determining by way of a computer reasoning system at least one measure for achieving the desired value of the service efficiency parameter.

The computer system may comprise any further step, any development or any further feature in order to provide any of the previously or subsequently discussed interactions, operating states, steps and functions. Specifically, any of the previous or subsequent explanations and developments regarding the method may also apply to the equivalent system. In general, the method may be performed by and/or carried out with a computer system according to any of the previous or subsequent aspects.

The computer system may comprise at least one computer and in particular only one computer (e.g. it may be a central computer system). Alternatively, the computer system may comprise a computer network in which a plurality of computers communicate with one another in order to e.g. jointly perform the method steps.

Each of the above units (the gathering unit and/or the first and second determination unit) may be realized as a software module, software component, software application or software program. These may be executable by at least one computer of the computer system. Alternatively, each of the above units may be realized as a respective computer of the computer system, said computers interacting with one another e.g. by forming a computer network of the computer system.

The computer system may generally be an AI-system (artificial intelligence). Additionally or alternatively, it may provide machine learning functions and/or may comprise algorithms (e.g. in form at least some of the units) that have been trained based on and/or generated by machine learning processes.

It is to be understood, that any further units may be provided for performing any of the further method steps discussed herein or, differently put, that the computer system is generally configured to perform any of the further method steps discussed herein. This relates, for example, to a driving circumstance definition unit discussed in the context of but not limited to the further details of the below embodiments. This unit may generally define driving circumstances for given vehicles and/or driving routes and in particular identify comparable driving circumstances for vehicles and/or driving routes e.g. within a public transport network.

In the following, an embodiment of the invention will be described with reference to the attached schematic figures. Features which correspond to one another with regard to their type and/or function may be assigned the same reference signs throughout the figures. In the figures:

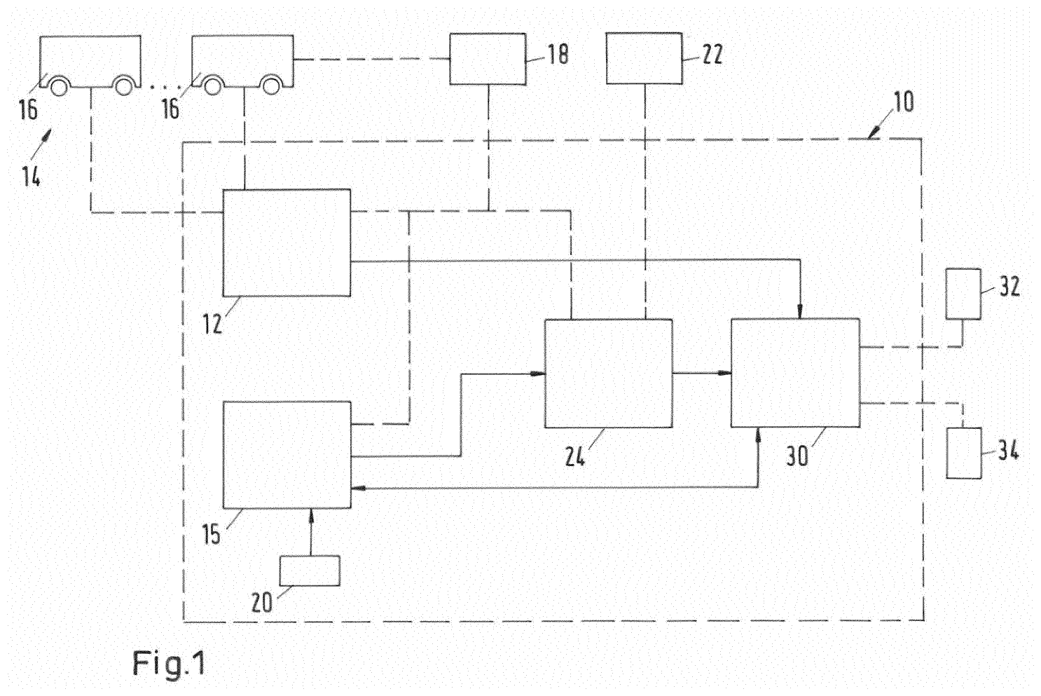

FIG. 1 shows an overview of a processing flow within a computer system according to an embodiment of the invention, the computer system performing a method according to an embodiment of the invention; and

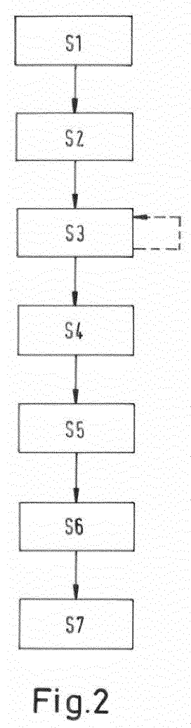

FIG. 2 shows a flowchart of the method performed by the computer system of FIG. 1.

FIG. 1 indicates a computer system 10 which in the shown example is realized as a single computer (e.g. a PC) which, however, is not mandatory (a network of a plurality of computers would equally be possible). In FIG. 1, a processing and in particular data flow of or, differently put, within the computer system 10 is shown. This flow takes place in accordance with a method carried out by the computer system 10 and is further explained below with reference to the flowchart of FIG. 2.

The computer system 10 is provided for improving the efficiency of a vehicle fleet 14 as schematically indicated in FIG. 1. Said vehicle fleet 14 consists of a number of single vehicles 16 which, as a mere example, are buses used in a public transport network of e.g. a city or region.

The computer system 10 may generally represent an AI-system (artificial intelligence) and may generally provide machine learning functions and/or may comprise algorithms (e.g. comprised by at least some of the units discussed herein) that have been trained based on and/or have been generated by machine learning processes.

The computer system 10 comprises several units that are realized as software components of software applications executed by a processing unit (e.g. a microprocessor). Thus, the representation of said units in FIG. 1 is to be understood in a functional manner (i.e. the respective units representing functional blocks and/or software modules) and is not to be understood as said units representing actual hardware components.

A first unit performing a first measure of the computer system 10 is a gathering unit 12. The gathering unit 12 gathers operating parameters relating to an operation of at least some of the vehicles 16. At least some of these parameters can gathered from the vehicles 16 e.g. directly by a wireless communication link between the vehicles 16 and the computer system 10 as indicated by dotted lines in FIG. 1. Yet, it is preferred to use typically already existing vehicle monitoring systems of an operator of the vehicle fleet 14, such as a so-called AVM database 18 as schematically illustrated in FIG. 1. Such a database may be accessed by and/or connected to the computer system 10 for retrieving the relevant operating parameters of the vehicles 16. According to one embodiment, the gathering unit 12 may be formed by and/or comprise a respective database and in particular the AVM database 18. Note that the gathering unit 12 may also gather parameters that are not directly linked to or delivered by a vehicle, such as weather or traffic data. Such parameters may be retrieved from a database (e.g. AVM database 18) or from online services.

The operating parameters, which may also be referred to as bus service parameters, may contain any of the examples listed in the general part of this description. The operating parameters may be vehicle specific and e.g. stored as vehicle specific datasets.

The computer system 10 further comprises a driving circumstance definition unit 15. Note that the consideration of driving circumstances and associated backgrounds is preferred, but merely optional. That is, the computer system 10 could also directly use the gathered operating parameters to generate recommendations without identifying comparable driving circumstances as discussed in the following.

The driving circumstance definition unit 15 receives the operating parameters from the gathering unit 12. Preferably, it also receives settings by means of a settings unit 20, said settings e.g. relating to criteria for identifying comparable backgrounds. The settings may e.g. define conditions according to which driving circumstances are classified as being comparable. This may include maximum allowable deviations between similar items of information contained in the driving circumstances of two vehicles 16.

As mere examples and not bound to the further details of the described embodiment, the following types of acceptable deviations that still allow for driving circumstances to be classified as being sufficiently comparable may be defined by the settings unit 20:
With respect to a driving route, a deviation of not more than 10% in regard to any of a number of crosswalks, a number of traffic lights, an average slope, a length, a number of bus stops and/or a number of average passengers defined in driving circumstances to be compared. The above percentage is only by way of example and could be adjusted, in particular dynamically e.g. in case no comparable driving circumstances can be identified.
With respect to a driving schedule, a deviation of not more than 10% between the points of time defined by different schedules to be compared. Additionally or alternatively, only similar operating points of times, or operating time spans such as both driving circumstances relating to operation during a weekday, during the morning or the like, may be required in order to classify driving circumstances as sufficiently comparable.
With respect to weather conditions, the same season and/or the same road conditions and/or deviations of not more than 10% with respect to an average temperature or a level of precipitation may be required for determining a sufficient comparability.

As will be detailed below, the settings unit 20 can dynamically adjust such settings, e.g. in response to not finding sufficiently comparable driving circumstances or in response to an increased training level of the computer system 10. This can be part of or implemented as a machine learning algorithm included in the settings unit 20.

Specifically, the driving circumstance definition unit 15 receives any of the information on driving conditions listed in the general part of this description as an input. This information may again be provided by a database and in particular by the AVM database 18. Said AVM database 18 also may include parameters (i.e. set or expected values) according to which the vehicles 16 should be operated e.g. along predetermined driving route. In any case, the AVM database 18 provides actually determined (i.e. measured) operating parameters of the vehicles 16 when driving along the driving routes.

As noted above, further inputs may be provided by the settings unit 20 in form of the settings according to which driving circumstances may be classified as comparable or not.

The driving circumstance definition unit 15, first of all, defines vectors defining one single driving circumstances e.g. for certain driving routes e.g. in a public transport network along of which a part of the vehicles 16 drive. Additionally or alternatively, the driving circumstance definition unit 15 also identifies comparable driving circumstances and e.g. outputs vectors in which at least two (i.e. a group of) driving circumstances that have been identified as being comparable to one another are summarized.

In the below table, an example of a respective vector including two driving circumstances is shown that, based on current settings received from the settings unit 20, have been identified as comparable:

| Bus Line ID | 1 | 29 |
|---|---|---|
| Geo | Geographical | Geographical |
| coordinates | area of the route, | area of the route, |
| | e.g. defined as | e.g. defined as |
| | bounding GPS | bounding GPS |
| | coordinates | coordinates |
| Scheduled | Working days, | Working days, |
| operating | 8:00-10:00 | 9:00-11:00 |
| time | | |
| Weather | Avg temp: 15° C. | Avg temp: 16° C. |
| conditions | Not rain | Not rain |
| Average | 5% | 4% |
| slope | | |
| Passengers | 300 | 390 |
| average | | |
| per day | | |
| Vehicle | Mercedes Citaro | Mercedes Citaro |
| | K. | K. |
| Time | 30′ | 32′ |
| scheduled | | |
| per lap | | |

Note that in case the driving circumstance definition unit 15 is not able to identify comparable driving circumstances within the available data, one or any combination of the following may be considered, which is again not limited to the further details of the description of embodiments:
The settings provided by the settings unit 20 may be loosened, such that finding comparable driving circumstances is more likely (i.e. due to said settings being less restrictive or limiting);
The number of variables (e.g. lines in the above table) considered when trying to identify comparable driving circumstances may be reduced;
The extent of at least one considered variable (herein also referred to as considered information) may be adjusted, such that finding comparable driving circumstances is more likely (i.e. may be adjusted to be less restrictive or limiting). For example, instead of considering a total geographical area of the routes only a starting and/or endpoint of the driving routes may be considered. As a further example, instead of the exact scheduled operating times, only the information regarding operating on working days or nonworking days may be considered.

Trying to identify comparable driving backgrounds may be done iteratively, e.g. by repeating any of the above measures until a sufficient amount of comparable driving backgrounds has been found.

A further unit of the computer system 10 is a first determination unit 24 that is configured to determine a service efficiency and, in the shown example, a value of at least one service efficiency parameter. When, as is generally preferred and applied in this embodiment, driving circumstances are considered and in particular comparable driving circumstances are identified, a service efficiency parameter may be identified with respect to each group of such comparable driving circumstances. For doing so, the first determination unit 24 receives e.g. a vector as noted above from the unit 15 in which the comparable driving circumstances are summarized.

As a further input, the first determination unit 24 receives operating parameters acting as efficiency indicators as discussed in the general part of the description. The efficiency indicators are values of operating parameters that are actually measured during operation of the vehicle fleet 14 and may e.g. be retrieved from the AVM database 18. The first determination unit 24 preferably considers, requests and/or identifies at least those efficiency indicators belonging to those driving circumstances that have been identified as being comparable to one another.

Note that according to an embodiment, it is also possible to consider efficiency indicators for each driving circumstance and to compute service efficiency parameters for each driving circumstance based thereon as an initial measure. At a later point, only those service efficiency parameters for driving circumstances that have been identified as being comparable to one another may then further be considered. For example, an average service efficiency parameter may be determined based on the service efficiency parameters of a group of comparable driving circumstances.

Various efficiency indicator values stemming from various vehicles 16 operating according to the one and same driving circumstance (e.g. by travelling along the driving route belonging to said driving circumstance) may be received this way. It is generally preferred (and not limited to further details of this embodiment) that the first determination unit 24 forms an average of the total amount of received efficiency indicator values for a certain driving circumstance and e.g. compares said average to expected values (see table below). The expected values are target values and e.g. formed by SLA information discussed herein.

More precisely, as a still further input, the first determination unit 24 receives expected values or levels of the efficiency indicators from a further database in form of an ERP (Enterprise Resource Planning) database 22. The ERP database 22 may, in a generally known manner, contain planned objective (i.e. set) values, conditions, SLAs and/or rules for operating the vehicle fleet 14. It may thus provide reference information for determining whether or not the received efficiency indicators (which describe an actual operation of the vehicle fleet 14) indicate a high or low efficiency.

Specifically, the information (i.e. target values) retrieved from the ERP database 22 can be referred to as reference information which is used for normalizing the efficiency indicators received from the AVM database 18. Even though this is not a mandatory measure, the normalization helps to define meaningful and practical indicators that can effectively be used in the context of a computer model discussed below.

Specifically, normalizing the efficiency indicators may include defining a value of each efficiency indicator relative to an expected (SLA or target) value thereof, for example by defining said value as a (e.g. percentage) deviation from an expected value. If a plurality of efficiency indicators are considered, each of these efficiency indicators may be normalized according to the same principle (e.g. as the percentage deviation discussed above) and an average of said normalized values can be formed, said average representing the service efficiency parameter that is eventually output by the first determination unit 24 (again preferably with respect to a group of comparable driving circumstances).

Note that retrieving relevant values from the ERP and AVM databases 14, 22 can require different filter functions to be provided by the first determination unit 24. For example, the first determination unit 24 may filter the values retrievable from said databases 14, 22 with regard to a certain time period that is to be considered e.g. so that the values to match the scheduling information associated with a certain driving circumstance.

As a mere example, a below vector is shown in which averaged efficiency indicators for one driving circumstance (i.e. the averaged efficiency indicators of vehicles 16 operating according to said driving circumstance) are listed alongside expected values thereof as retrieved from the ERP database 22:

| | Expected | Actual (average) |
|---|---|---|
| Avg. Consumption (l/100 km) | 55 | 65 |
| Punctuality % | 90 | 85 |
| Incidents rate (n/100 km) | 0.01 | 0.02 |
| Avg. speed (km/h) | 12 | 13 |
| Satisfaction (1-10) | 8 | 6 |
| Passengers carried out | 200 | 180 |
| . . . | . . . | . . . |
| Driving pattern | 10 | 9 |
| Output (normalized)→ | | 8 |

Note that as a general aspect of this invention, not only indicators describing a desired performance (e.g. a positive performance result or outcome) but also indicators describing a cost or negative co-effect are considered. Above, satisfaction and punctuality are positive indicators, whereas as incidents an average consumption describe the costs of performance. Overall, this approach delivers a more representative and balanced indication of the achieved efficiency.

The row “output” includes the normalized value that is eventually output, i.e. the determined service efficiency parameter. In the shown example, said service efficiency parameter has a value of 8 out of a maximum 10 (i.e. 80%). As noted above, it may be computed as the average percentage deviation of each of the efficiency indicator values from their respective expected target values (note that the values included in the table are merely exemplary and may not lead to a respective averaged 80% deviation, i.e. the value of 8 may also result from defining a different normalization principle or scale).

Eventually, datasets (e.g. matrices) or data collections according to the above table may be output in which for each driving circumstance expected values of the efficiency indicators along with their actually recorded values are summarized and which preferably also includes the determined service efficiency parameter. Such datasets may also be formed for comparable driving circumstances (i.e. include expected as well as actual (averaged) values for a group of comparable driving circumstances).

This information may be used as a reference and/or benchmark for identifying an actual best practice driving pattern (see below) from a number of driving patterns e.g. for a group of comparable driving circumstances. For example, a driving pattern may be categorized based on such information, wherein the categorization may include said pattern having been evaluated and being associated with a deterministic and/or specific driving circumstance.

Note that the first determination unit 24 is further configured to identify those operating parameters belonging to a certain vehicle operation in the context of a driving circumstance, said operating parameters forming driving patterns (see also table in general part of description). More precisely, these operating parameters may be summarized as data collections that are referred to as driving patterns, said driving patterns being driving-circumstance-specific. This may be achieved by checking which vehicles operate along a certain driving route (retrievable from the databases 18, 22), since a driving circumstance may be specific to and stems from a certain driving route. Thus, operating parameters of each vehicle 16 actually operating according to a certain driving circumstance may be retrieved as respective driving patterns and preferably also comprise a driver ID (again retrievable from databases 18, 22).

Also, the first determination unit 24 identifies a best practice performance out of the available data that is marked by the highest efficiency. This may be used as an input (e.g. as a benchmark) for second determination unit 30. For doing so it compares for each driving pattern associated with a group of comparable driving circumstances actual operating parameter values to target ones and computes an efficiency similar to the above table.

Specifically, the first determination unit 24 identifies the driving pattern and its operating parameters that achieves the highest service efficiency throughout the population of driving patterns occurring in connection with the group of comparable driving circumstances. Again, this can be referred to as categorizing said driving pattern. These operating parameters form a preferred set of operating parameters and the value of the service efficiency parameter achieved thereby forms a desired level of service efficiency. Again, such determinations may be carried out with respect to groups of comparable driving circumstances (e.g. by finding the best practice driving pattern occurring within said group). If this fails (e.g. since no driving pattern with a preferred efficiency exists), the definition of driving circumstances and in particular comparable driving circumstances can be iteratively re-adjusted until this is the case (see arrow between 24 and 14/20 in FIG. 1). Additionally or alternatively, it can be concluded this is due to non-driver/driving related aspects (e.g. due to poor maintenance or route planning) and appropriate measures may thus be selected).

Further, the computer system 10 comprises a second determination unit 30 that can also be referred to as an automatic learning engine or an artificial intelligence unit. It preferably receives the operating parameters from the gathering unit 12. Also it preferably receives the driving circumstances and preferably comparable driving circumstances from the driving circumstance definition unit 15. Still further, it preferably receives the output datasets from the first determination unit 24 or, generally, at least the service efficiency parameters as well as the driving patterns determined thereby.

Overall, the following information, alone or in any combination thereof, are thus preferably available to the second determination unit 30: the driving patterns (i.e. operating parameters) per driving circumstance, information on which driving circumstances are comparable to one another and the service efficiency parameters per driving circumstance (or of each driving circumstance out of a comparable group of driving circumstances) as well as a best practice driving pattern (e.g. a preferred set of operating parameters) for each group of comparable driving circumstances.

As further optional, yet preferred inputs, the second determination unit 30 may access a knowledge database 32 in which historical data are stored, in particular driver- and/or vehicle-related historical data. Also, it may access a measure database 34 (or recommendation database) which includes pre-stored measures that the second determination unit 30 can choose from and recommend e.g. to a system operator in order to improve the efficiency. For example, training plans, training methods or motivational measures may be stored in said database 34.

Note that any databases 18, 20, 32, 34 discussed herein are depicted externally of the computer system 10 (and connected thereto by communication links) but could also be integrated into the computer system 10, e.g. by being stored in a storage unit of the computer system 10.

The second determination unit 30 preferably works on a driving-circumstance-specific basis and determines for each driving circumstance (and in particular for each comparable group of driving circumstances) measures for improving the efficiency of those entities (driver, vehicle, line) that fail to deliver said best practice driving pattern. For doing so, the best practice driving pattern is used as a benchmark and the second determination unit 30 may, based thereon, determine which operating parameters need improvement to achieve said best practice and which measures would be helpful in this regard.

For doing so, it uses the driving patterns associated with a certain driving circumstance as input parameters of a computer reasoning system. In the depicted example, this reasoning system is a computer model, such as a rule-based decision tree model generated by machine learning.

By way of a machine learning process and/or expert knowledge, the computer model comprises at least an initial set of rules. Based on these rules and preferably based on a difference between currently considered operating parameters (e.g. of non-best practice-drive patterns) and the previously discussed best practice, measure for efficiency improvement may then be identified. This, again, is preferably done for each group of comparable driving circumstances. Specifically, for each vehicle, driver, line or driving pattern not operating according to the best practice and based on the respectively associated operating parameters, suitable measures may be identified for improving the efficiency.

For example, all operating parameters associated with a certain driver may be gathered and compared to the respective best practice operating parameters. Based on an observed difference therebetween, the model may identify suitable (e.g. training) measures for said driver. Alternatively, average operating parameters for all non-best-practice driving patterns associated with a certain group of comparable driving circumstances may be gathered and an average deviation from the best practice parameters may be considered. Based thereon, measures for improvement e.g. for all drivers or vehicle falling short of the best practice may be output.

Accordingly, the computer model is used to identify which operating parameters should be changed in which way in order to adjust and in particular increase the service efficiency parameter of e.g. a certain driving pattern. Also, it identifies the measures for achieving such changes.

In this context, an advantage of defining groups of comparable driving circumstances becomes evident: due to a plurality of driving circumstances being classified as comparable, the number of available input data (i.e. the driving patterns for each of said driving circumstances) increases. On the other hand, when a measure has been identified with respect to a certain driving circumstance (e.g. a driver operating according to said driving circumstance), this measure can also be applied to any comparable driving circumstance, thereby spreading the measures quickly throughout the vehicle fleet 14 and speeding-up the vehicle fleet optimization.

The second determination unit 30 may determine the measures for improving the efficiency, for example, by referring to the knowledge database 34. There, suitable training plans to train the drivers to drive according to the best possible driving pattern may be stored and/or to overcome present efficiency shortfalls.

For example, the second determination unit 30 may identify which operating parameters need to be improved to come close to the best practice driving pattern and training plans associated with said operating parameters may be recommended. Generally, the training plans may be output via smartphone apps accessed by the drivers or they may be put into practice as face-to-face session with a human trainer. It is also possible that the computer system 10 defines driving simulations for a driving simulator used for driver training e.g. at an educational centre of the vehicle fleet operator.

The contents of such training plans may be prestored. Alternatively, the second determination unit 30 may be configured to compose the contents of such training plans e.g. in view of which operating parameters should be improved. As an example, a training plan may e.g. be directed at a smoother approach to bus stops and/or roundabouts in order to increase passenger comfort. As a further example, a training plan may strengthen techniques to reduce a driver's stress level.

Also, suitable measures for maintaining the vehicles can be output (e.g. by performing battery checks or a tyre pressure control with a certain frequency) and/or for planning the driving route as such (e.g. by changing a layout thereof or adapting the number of stops).

Note that based on such identified measures, the AVM and/or ERP database 18, 22 may be automatically reconfigured. This may be particularly relevant if no driving pattern can be identified that achieves a desired (best practice) efficiency. In this case, it may be concluded that other matters prevent the drivers from operating efficiently, so that improvements in maintenance and/or route planning might be necessary.

Thus, according to a general aspect of this invention, the preferred set of operating parameters may relate to operating parameters that are at least indirectly controlled and/or affected by a driver, whereas measures may also focus on non driver controlled or affected aspects, in particular when no set of operating parameters (i.e. driving pattern) achieving a desired efficiency can be identified.

Still further, the second determination unit 30 may access the optional knowledge database 32 and determine developments of certain drivers and/or vehicles compared to the historic data stored in said database 32. For example, if a certain driver and/or vehicle 16 produces operating parameters and driving patterns that are far from best practice, it can be checked whether this has been different in the past. In case of the vehicle, a sudden decrease in driving performance may indicate a need for maintenance. In case of the driver, a sudden decrease in driving performance may indicate a need for training or personal assistance.

Any of the measures that the second determination unit 30 identifies can be stored and collected for documentation purposes but also in order to be checked later on. Specifically, as part of further tuning or, differently put, training of the computer model(s) comprised by the second determination unit 30, an effectiveness of the suggested measures can be checked. For doing so, changes of the service efficiency parameter (e.g. for a certain group of driving circumstances) after a measure has been identified and output by the second determination unit 30 can be tracked (e.g. over a longer time span). For example, depending on the detected changes the computer model may be adjusted by downweighting or upweighting the respective measure.

Note that by way of a double arrow between units 14 and 30, a possibility to provide feedback to the driving circumstance definition units 14 is indicated. This is beneficial in case the second determination unit 30 is not able to determine suitable measures for efficiency improvement and the operation of the driving circumstance definition 14 (and/or the settings unit 20) should be adjusted so that driving circumstances and in particular criteria for defining comparable driving circumstances are defined differently.

In the following, some specific examples are included on how and what measures might be recommended (and even be automatically implemented) by the second determination unit 30:
In case of the passenger satisfaction indicator being low, the frequency/scheduling of the driving routes associated with a certain group of driving circumstances can be checked. Specifically, if the customer satisfaction indicator is at a low value, it can be determined that said frequency/scheduling is too harsh and could be affecting the driving style (and thereby indirectly the passenger satisfaction).
The second determination unit 30 may thus, as an identified measure, recommend adjusting the frequency of vehicles operating on a certain driving route and, automatically, configure any of the databases 18, 22 accordingly. Additionally or alternatively, it may generate a specific training plan for those drivers with more problems to adjust to the timing. Further reassignment of drivers among lines or even, e.g. in case of low customer satisfaction but an already relatively high frequency/scheduling, incorporation of an additional vehicle unit to the more time stressed driving routes may be recommended. Reassignment may e.g. be done so that drivers who perform bad in terms of frequency are assigned to lines with less traffic or that are classified as less difficult. Difficulty of lines can be classified based on expert knowledge (e.g. interurban lines can be classified as more difficult than central city lines). The effectiveness of such reassignments between different lines can be learned by way of the above effectiveness indicator, thereby consecutively training e.g. the knowledge database 34.
As a further example, it can be determined that for driving patterns relating to a certain group of comparable driving circumstances, the average fuel consumption is regular, but the extent of inertia driving is differential across the population of drivers. Accordingly, a specific training plan for inertia driving can be defined and launched through the available mechanisms (e.g. face-to-face training, driving simulator or software application).
In case an increase of incidents/accidents along certain driving route are detected (e.g. based on a comparison to the knowledge database 32) and, preferably, this is detected as having a major impact on a so far rather low service efficiency parameter, this may be automatically documented e.g. in the ERP database 22. Moreover, as suitable measures reminders and/or advise may be given to drivers (e.g. through a software application) so that they can be aware of these occurrences and better learn how to avoid them.
The vehicles' maintenance plan may be updated. This may include incorporating specific (maintenance) revisions for those vehicles having mechanical incidents, high alarm rates and/or increased fuel consumption.

FIG. 2 shows a flowchart of a method that can be carried out by the computer system 10 described in FIG. 1 and has partially been already described in connection with said figure. The below sequences are not to be understood as a strict temporal order and, unless evident otherwise, other sequences and/or parallel executions of at least some of the steps are possible. Also, not each of the steps is mandatory and the method may include any combination said single steps.

As a first step S1, actual operating parameters, which may also be referred to as actual services states and/or service levels, of the vehicle fleet 14 are gathered by way of the AVM database 18 and/or the gathering unit 12. As a second step S2, information on driving circumstances are gathered from the AVM database 18. This information describes a framework in which the vehicles 16 operate and may also be referred to as bus service parameters. In a subsequent step S3, comparable driving circumstances are identified e.g. by considering current settings that define criteria according to which driving circumstances may be classified as comparable. As indicated by a dotted arrow, this may take some iterations of or within step S3 e.g. by adapting settings for classifying driving circumstances as comparable and/or adjusting the amount or extent of considered information.

In a step S4, a service efficiency parameter describing a current efficiency level is computed, preferably for each driving circumstance and in particular group of comparable driving circumstances. For doing so, operating parameters acting as efficiency indicators may be retrieved from e.g. an ERP database 22. In the optional step S5, these parameters are normalized based on target values for said operating parameters. In step S6, based on the (normalized) efficiency indicators, a best practice (i.e. most efficient) driving pattern is identified that acts as a benchmark for a certain (group of comparable) driving circumstance(s). Note that in case no best practice driving pattern can be identified that achieves a desired efficiency, the criteria for defining comparable driving circumstances may be adjusted (and thereby the definition of driving patterns resulting therefrom) again and in particular may be adjusted iteratively until said desired efficiency is reached.

A computer model is then used to determine measures for each driving pattern, vehicle or driver associated with a given group of comparable driving circumstances that do not operate according to said best practice. These measures are intended to improve the achieved efficiencies when operating the vehicle fleet 14 in connection with said comparable driving circumstances. As a result, suitable measures for efficiency improvement are identified by means of said computer model and output by the mechanisms discussed above.

1. Computer-system-implemented method for improving an efficiency of a vehicle fleet, the method comprising:
a) Determining; one or more driving circumstances for two or more vehicles within the vehicle fleet and identifying one or more comparable driving circumstances;
b) Gathering one or more operating parameters relating to an operation of the vehicle fleet, including gathering specific operating parameters for the two or more vehicles having the comparable driving circumstances;
c) Determining a service efficiency for at least the two or more vehicles having the comparable driving circumstances;
d) Determining at least one preferred set of operating parameters for the two or more vehicles having the comparable driving circumstances, and identifying, based on the at least one preferred set of operating parameters, a desired level of service efficiency for at least the two or more vehicles having the comparable driving circumstances;
e) Determining, using a computer reasoning system implemented in the computer system, at least one measure for achieving a desired value of a service efficiency parameter corresponding to the desired level of service efficiency, wherein the measure is implementable with respect to at least one of the one or more of the comparable driving circumstances; and
f) Determining an effect indicator for a particular measure of the at least one measure determined in e) and adapting the computer reasoning system based on the effect indicator;
wherein an amount and/or an extent of at least a portion of information considered as a part of the one or more driving circumstances is adjusted in step a) when failing to identify a comparable driving circumstance.

2. The method according to claim 1, wherein the computer reasoning system determines the at least one measure based on a comparison of at least a portion of the gathered one or more operating parameters to the at least one preferred set of operating parameters.

3. The method according to claim 1, wherein the at least one preferred set of operating parameters is determined from a particular vehicle of the two or more vehicles having the comparable driving circumstances, the particular vehicle having a better than average service efficiency.

4. The method according to claim 1, wherein the one or more operating parameters are based on or determined or being determined based on at least one of the following:
an inertia driving;
an average speed;
an occurrence of a vehicle alarm;
at least one of a driver stress level or biometric driver data;
an approach of the vehicle to a predetermined stop;
a utilization of an engine idle mode;
a utilization of at least one of a retarder, air conditioning, or at least one braking device;
a passenger comfort level; or
an occurrence of a critical driving situation.

5. The method according to claim 1, wherein the service efficiency is determined based on at least one operating parameter, a respective target value for the at least one operating parameter, and at last one of: comparing the at least one operating parameter to the target value for the at least one operating parameter or normalizing the at least one operating parameter using the target value for said operating parameter.

6. The method according claim 5, wherein the at least one operating parameter and respective target value includes one or more of:
a fuel consumption level or a battery consumption level for at least one of the two or more vehicles having the comparable driving circumstances;
a punctuality percentage for at least one of the two or more vehicles having the comparable driving circumstances;
a passenger satisfaction score;
a number of transported passengers;
a cost per transported passenger; or
a rate of incidents for at least one of the two or more vehicles having the comparable driving circumstances.

7. The method according to claim 1,
wherein the one or more driving circumstances are determined by at least one of:
a driving route layout;
a driving schedule along the driving route;
a vehicle type;
one or more predetermined stops along the driving route;
an average passenger number;
an average slope along a driving route;
a number of traffic lights and/or crosswalks along the driving route; or
weather conditions along the driving route.

8. The method according to claim 1, wherein a criterion for determining whether or not driving circumstances are comparable is adjusted as function of a training level of the computer reasoning system.

9. The method according to claim 1, further comprising:
at least one of: communicating or implementing the at least one measure identified in step e).

10. The method according to claim 1, wherein for determining the at least one measure in step e), a rule-based model is used.

11. The method according to claim 1,
wherein the at least one measure determined in step e) is one of:
adjusting a frequency and/or a scheduling of the one or more vehicles along at least one driving route;
determining one or more training tools, one or more training methods, and/or one or more rewards for one or more staff members that work with the vehicle fleet;
adjusting a maintenance schedule of at least one of the two or more vehicles of the vehicle fleet; or
reassigning one or more drivers and/or at least one vehicle of the two or more vehicles to a different line of the vehicle fleet.

12. Computer system for improving an efficiency of a vehicle fleet, comprising:
a) a gathering unit configurable to gather one or more operating parameters relating to an operation of the vehicle fleet;
b) a first determination unit configurable to:
determine a service efficiency at least one vehicle of the vehicle fleet;
determine at least one preferred set of operating parameters for the at least one vehicle of the vehicle fleet; and
identify, based on the at least one preferred set of operating parameters, a desired level of the service efficiency for the at least one vehicle of the vehicle fleet; and
c) a second determination unit configurable to determine using a computer reasoning system, at least one measure for achieving a desired value of a service efficiency parameter corresponding to the desired level of service efficiency for the at least one vehicle of the vehicle fleet;
wherein the computer system is further configurable to:
determine one or more driving circumstances for one or more vehicles within the vehicle fleet and to gather one or more operating parameters with the gathering unit for at least two vehicles of the vehicle fleet having one or more comparable driving circumstances;
adjust a number and/or an extent of at least a portion of information considered as a part of the one or more driving circumstances when failing to identify a comparable driving circumstance; and
determine an effect indicator for a particular measure of the at least one measure determined by the second determination unit and to adapt the computer reasoning system based on the effect indicator.

13. The method according to claim 1, wherein the vehicle fleet is a vehicle fleet used for public transport.

14. The method according to claim 4, wherein the vehicle alarm is a CAN bus alarm.

15. The method according to claim 10, wherein the rule-based model is a decision tree model.

16. The method according to claim 11, wherein adjusting the frequency and/or the scheduling of the one or more vehicles is based on a passenger satisfaction score.

17. The computer system of claim 12, wherein the computer system is further configurable to:
determine the at least one measure based on a comparison of at least a portion of the gathered one or more operating parameters to the preferred set of operating parameters, wherein the at least one preferred set of operating parameters is determined from a particular vehicle of the two or more vehicles having the comparable driving circumstances, the particular vehicle having a better than average service efficiency.

18. The computer system of claim 12, wherein the vehicle fleet is a vehicle fleet used for public transport.

19. A non-transitory computer-readable medium with instructions stored thereon, which, when executed by a processor of a computing system, cause the processor to:
gather an operating parameter relating to an operation of a vehicle within a vehicle fleet, wherein the vehicle fleet is a vehicle fleet used for public transport;
determine a service efficiency for at least one vehicle of the vehicle fleet;
determine at least one preferred set of operating parameters for the at least one vehicle of the vehicle fleet;
identify, based on the at least one preferred set of operating parameter, a desired level of service efficiency for the at least one vehicle of the vehicle fleet;
determine at least one measure for achieving a desired value of a service efficiency parameter corresponding to the desired level of service efficiency for the at least one vehicle of the vehicle fleet;
determine a driving circumstance for one or more vehicles within the vehicle fleet;
gather one or more operating parameters for at least two vehicles of the vehicle fleet having one or more comparable driving circumstances; and
adjust at least one of an amount of or an extent of at least a portion of information considered as a part of the one or more driving circumstances when failing to identify a comparable driving circumstance.

20. The non-transitory computer-readable medium of claim 19, wherein the instructions further cause the processor to:
determine the at least one measure based on a comparison of at least a portion of the gathered one or more operating parameters to the preferred set of operating parameters, wherein the at least one preferred set of operating parameters is determined from a particular vehicle of the two or more vehicles having the comparable driving circumstances, the particular vehicle having a better than average service efficiency.
